(19) United States
(12) Patent Application Publication
(10) Pub. No.: US 2026/0229597 A1
(43) Pub. Date: Aug. 6, 2026

(54) ELECTROCHEMICAL APPARATUS AND ELECTRONIC APPARATUS

(71) Applicant: Dongguan Amperex Technology Limited, Dongguan, (CN)

(72) Inventors: Dongyang Yan, Dongguan (CN); Xianhui Xie, Dongguan (CN)

(73) Assignee: Dongguan Amperex Technology Limited, Dongguan, (CN)

(21) Appl. No.: 19/630,632

(22) Filed: Mar. 27, 2026

Related U.S. Application Data
(63) Continuation of application No. PCT/CN2023/122767, filed on Sep. 28, 2023.

(51) Int. Cl. H01M 10/0567; H01M 4/66; H01M 10/0525; H01M 10/0587

(52) U.S. Cl. CPC H01M 10/0567; H01M 4/662; H01M 10/0525; H01M 10/0587; H01M 2220/30; H01M 2300/0025

(57) ABSTRACT

An electrochemical apparatus including a positive electrode and an electrolyte, the positive electrode includes a positive electrode current collector and a positive electrode mixture layer disposed on a surface of the positive electrode current collector. The positive electrode current collector includes a first region with the positive electrode mixture layer disposed on two surfaces, a second region with the positive electrode mixture layer disposed on only one surface, and a third region with no positive electrode mixture layer disposed on either surface. An average width of the first region is a centimeters, an average width of the third region is b centimeters, and an elongation rate of the positive electrode current collector is x, where x=a/b−1. The electrolyte includes a specific type and a specific content (y %) of lithium salt additive A, and y≥x.

### CROSS REFERENCE TO THE RELATED APPLICATIONS

This application is a continuation under 35 U.S.C. § 120 of international patent application PCT/CN2023/122767 filed on Sep. 28, 2023, the entire content of which is incorporated herein by reference.

### TECHNICAL FIELD

The present application relates to the field of energy storage, and specifically to an electrochemical apparatus and an electronic apparatus.

### BACKGROUND

With the widespread application of electrochemical apparatuses (for example, lithium-ion batteries) in electronic products such as mobile phones, laptops, tablets, Bluetooth headsets, and wearable watches, the performance requirements for these apparatuses are becoming increasingly stringent, such as in terms of energy density. When an energy density of a lithium-ion battery increases to above 700 Wh/L, a voltage of an electrochemical apparatus will rise to above 4.48 V, making a lithium salt in an electrolyte more unstable under high-voltage windows, prone to reacting and decomposing with trace amounts of water. This corrodes a positive electrode, and causes dissolved elements to easily accumulate and form purple spots, black spots, or lithium precipitation, severely affecting the safety of lithium-ion battery.

In view of this, it is indeed necessary to provide an electrochemical apparatus with improved safety.

### SUMMARY

The present application seeks to address, at least to some extent, at least one problem existing in the related field by providing an electrochemical apparatus.

According to one aspect of the present application, an electrochemical apparatus is provided in the present application, which includes a positive electrode and an electrolyte. The positive electrode includes a positive electrode current collector and a positive electrode mixture layer disposed on a surface of the positive electrode current collector, the positive electrode current collector includes a first region, a second region, and a third region, the two surfaces of the first region each is provided with the positive electrode mixture layer, one surface of the second region is provided with the positive electrode mixture layer, and neither surface of the third region is provided with the positive electrode mixture layer. An average width of the first region is a centimeters, an average width of the third region is b centimeters, and an elongation rate of the positive electrode current collector is x, where x=a/b−1. The electrolyte includes a lithium salt additive A, the lithium salt additive A is at least one selected from lithium tetrafluoroborate, lithium bis(oxalato)borate, lithium difluoro(oxalato)borate, lithium difluorophosphate, lithium difluoro bis(oxalato)phosphate, lithium bis(fluorosulfonyl)imide, or lithium bis(trifluoromethanesulfonyl)imide, and based on a mass of the electrolyte, a content of a lithium salt additive A is y %, with y being in the range of 0.1 to 3; where y≥x.

According to an embodiment of the present application, x≤0.8.

According to an embodiment of the present application, x≤0.4.

According to an embodiment of the present application, 0.1≤y≤1.5.

According to an embodiment of the present application, the positive electrode current collector is an aluminum foil, and the aluminum foil includes at least one element selected from Mg, Ti, Cr, Cu, Fe, Mn, Ni, Si, V, Zn, or Gr.

According to an embodiment of the present application, a content of element aluminum in the positive electrode current collector is greater than or equal to 60%.

According to an embodiment of the present application, the aluminum foil includes element Si, and based on a total mass of the positive electrode current collector, a mass percentage content of the element Si is less than or equal to 0.5%.

According to an embodiment of the present application, the electrolyte further includes LiPF₆, and based on a mass of the electrolyte, a content of LiPF₆ is z %, with z being in the range of 5 to 20.

According to an embodiment of the present application, 0.01≤y/z≤0.5.

According to an embodiment of the present application, a charge cut-off voltage of the electrochemical apparatus is in a range of 4.41 V to 4.5 V.

According to an embodiment of the present application, the third region is disposed at a tail end, and an area of the third region accounts for 15% to 30% of an area of an outermost positive electrode current collector.

According to another aspect of the present application, an electronic apparatus is provided, which includes the electrochemical apparatus described in the present application.

The present application, by optimizing the structural parameters of the positive electrode and combining it with a specific type and content of lithium salt, can mitigate the sensitivity of the chemical system in the electrochemical apparatus to water, significantly improving the safety of the electrochemical apparatus.

Additional aspects and advantages of the present application will be partially described, shown, or elucidated through the implementation of the embodiments of the present application in the subsequent description.

### BRIEF DESCRIPTION OF DRAWINGS

The drawings necessary for describing the embodiments of the present application or the prior art will be briefly described below to facilitate the description of the embodiments of the present application. Obviously, the drawings described below are only some embodiments of the present application. For those skilled in the art, without requiring creative effort, other drawings of embodiments can still be obtained based on the structures illustrated in these drawings.

FIG. 1 shows an unfolded photograph of a wound cell.

FIG. 2A shows a front view of a positive electrode according to an embodiment.

FIG. 2B shows a top view of a positive electrode according to an embodiment.

FIG. 3A shows a schematic diagram of a wound cell with an embedded tab structure.

FIG. 3B shows a schematic diagram of a wound cell with a non-embedded tab structure.

FIG. 3C shows a schematic diagram of a wound cell with a multi-tab structure.

FIG. 4 shows a photograph of a normal interface of a positive electrode after cycling.

FIG. 5 shows a photograph of an abnormal interface of a positive electrode after cycling.

### DETAILED DESCRIPTION

The embodiments of the present application will be described in detail below. The embodiments of the present application should not be construed as limiting the present application.

In the detailed description and claims, a list of items connected by the term “at least one of” may mean any combination of the listed items. For example, if items A and B are listed, the phrase “at least one of A and B” means only A; only B; or both A and B. In another instance, if items A, B, and C are listed, the phrase “at least one of A, B, and C” means only A; only B; only C; A and B (excluding C); A and C (excluding B); B and C (excluding A); or all of A, B, and C. Item A may include a single element or multiple elements. Item B may include a single element or multiple elements. Item C may include a single element or multiple elements.

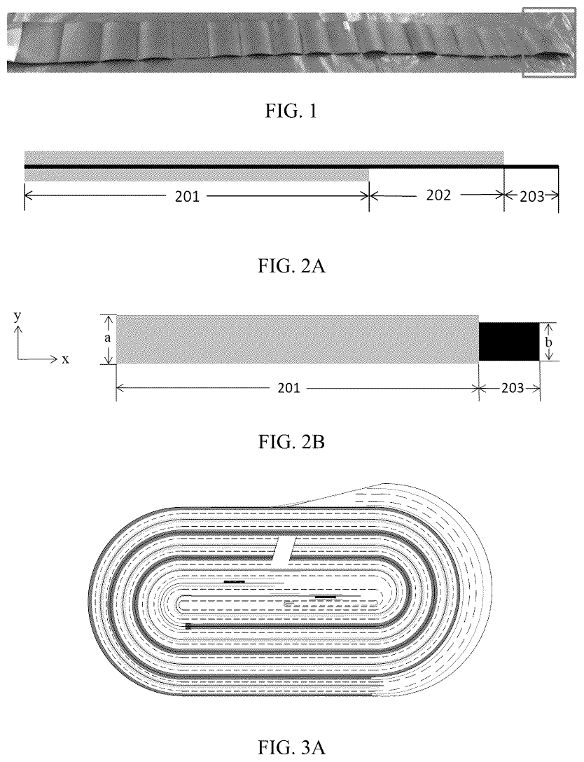

Electrochemical apparatuses (for example, lithium-ion batteries) have been widely used in various fields due to their superior performance, and the performance requirements for them are becoming increasingly high, such as in terms of energy density and safety. In high-voltage, high-energy-density electrochemical apparatuses, trace amounts of water and impurity elements can affect the performance of electrochemical apparatuses, deteriorating the health of electrochemical apparatus interfaces after cycling and impacting the safety of electrochemical apparatuses. Specifically, when an energy density of an electrochemical apparatus increases to above 700 Wh/L, a voltage of the electrochemical apparatus rises accordingly (for example, ≥4.48 V). Under a high-voltage window, a lithium salt in an electrolyte becomes more unstable, easily reacting and decomposing with trace amounts of water, corroding a positive electrode (for example, aluminum foil), and causing elements (for example, Si) in the positive electrode to dissolve out. The dissolved elements tend to accumulate at a positive electrode-separator-negative electrode interface, preventing normal lithium ion intercalation and deintercalation at the accumulation site, and the dissolved elements further accumulate to form purple spots, black spots, or lithium precipitation, thereby posing significant safety risks. This phenomenon is most evident at the tail of the positive electrode (corresponding to the outermost turn of the wound cell), because in the design of wound cells, the outermost turn is usually a positive electrode plate coated on one surface, and a large area of the positive electrode current collector is exposed to free electrolyte, with dissolved out products after corrosion easily accumulating at the interface between the separator and the positive electrode corresponding to the two folds at the tail of the wound cell. FIG. 1 shows an unfolded photograph of a wound cell, where the portion within the box represents the two folds at the tail of the wound cell.

To address the above issues, the present application provides an electrochemical apparatus, which includes a positive electrode and an electrolyte, where the positive electrode includes a positive electrode current collector and a positive electrode mixture layer disposed on a surface of the positive electrode current collector, the positive electrode current collector sequentially includes a first region, a second region, and a third region along a length direction, two surfaces of the first region each are provided with the positive electrode mixture layer, one surface of the second region is provided with the positive electrode mixture layer, and neither surface of the third region is provided with the positive electrode mixture layer. An average width of the first region is a centimeters, an average width of the third region is b centimeters, and an elongation rate of the positive electrode current collector is x, where x=a/b−1. The electrolyte includes a lithium salt additive A, the lithium salt additive A is at least one selected from lithium tetrafluoroborate (LiBF₄), lithium bis(oxalato)borate (LiBOB), lithium difluoro(oxalato)borate (LiDFOB), lithium difluorophosphate (LiDFP), lithium difluoro bis(oxalato)phosphate (LiDODFP), lithium bis(fluorosulfonyl)imide (LiFSI), or lithium bis(trifluoromethanesulfonyl)imide (LiTFSI), and based on a mass of the electrolyte, a content of the lithium salt additive A is y %, with y being in the range of 0.1 to 3; where y≥x.

LiBF₄, LiBOB, LIDFOB, LiDFP, LiDODFP, LiFSI, and LiTFSI all have high ionic conductivity and a wide electrochemical window, enabling high-voltage output. The addition of these lithium salt additives offers advantages over traditional LiPF₆. For example, LiTFSI is used as an example.

(1) Better thermal stability: LiTFSI is more stable than LiPF₆, and less prone to decomposition and gas production, thereby reducing safety hazards in electrochemical apparatuses.

(2) Lower water sensitivity, and reduced dissolution of metal ions: Incoming electrolyte and cell preparation processes contain trace amounts of water (100-200 ppm), and lithium salts are prone to decomposition upon encountering water at high temperatures, producing by-products or gases, thereby affecting the performance of electrochemical apparatuses. As compared with pure LiPF₆, products of LiTFSI hydrolysis are less corrosive, and less likely to further corrode metal positive electrode current collectors and positive electrode active materials, thereby reducing the dissolution of metal ions. The specific reactions are as follows:

The hydrolysis reaction of LiPF₆ is as follows:

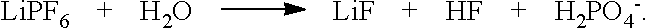

In this reaction, water molecules react with LiPF₆ to produce lithium fluoride, hydrofluoric acid, and hydrogen phosphate ions, where hydrofluoric acid is highly corrosive.

The hydrolysis reaction of LiTFSI is as follows:

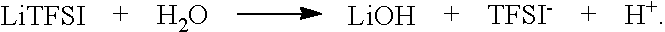

In this reaction, LiTFSI is decomposed by water molecules in water into Li⁺ and TFSI⁻, while releasing H⁺ and OH⁻ ions. This reaction does not produce hydrofluoric acid, thus reducing the corrosiveness to the positive electrode current collector in the electrochemical apparatus.

Adding a certain content of LiTFSI to the electrolyte can mitigate the corrosion of the positive electrode current collector by the electrolyte while maintaining the excellent conductivity/rate performance of LiPF₆, especially reducing the precipitation of element silicon in the positive electrode current collector (for example, aluminum foil), and avoiding the formation of purple spots, black spots, or lithium precipitation at the interface.

Additionally, as shown in FIG. 2A, the positive electrode current collector includes a first region 201 with the positive electrode mixture layer disposed on two surfaces, a second region 202 with the positive electrode mixture layer disposed on one surface, and a third region 203 with no positive electrode mixture layer disposed on either surface. Due to the different arrangements of the positive electrode mixture layer, the thicknesses of the three regions vary. During the cell preparation process, the positive electrode current collector undergoes processes such as cold pressing of the electrode plate, hot pressing of the cell, and formation hot pressing, resulting in elongation in the planar XY direction of the positive electrode current collector (as shown in FIG. 2B). Due to the difference in the ratio of overpressure applied by the cold pressing roller to the thicker region (that is, the first region) compared to the thinner region (that is, the third region) of the positive electrode, the elongation rate of the positive electrode current collector can reflect the magnitude of pressure used during the cold pressing process.

The method for testing the elongation rate of the positive electrode current collector is as follows: disassemble the electrochemical apparatus to obtain the positive electrode, measure the average width of the first region of the positive electrode current collector where the positive electrode mixture layer is disposed on two surfaces (take three points dispersed within the first region for testing and calculate the average value as the average width of the positive electrode current collector in the first region), denoted as a centimeters (as shown in FIG. 2B); measure the average width of the third region of the positive electrode current collector where no positive electrode mixture layer is disposed on either surface (take three points dispersed within the third region for testing and calculate the average value as the average width of the positive electrode current collector in the third region), denoted as b centimeters (as shown in FIG. 2B); and calculate the elongation rate x of the positive electrode current collector by using the following formula: x=a/b−1.

The elongated positive electrode current collector carries the risk of localized microcracks, where more grain boundary defect sites are exposed at the microcracks, making it more prone to concentrated corrosion reactions and accelerating the precipitation of impurity elements in the positive electrode current collector. A greater elongation rate of the positive electrode current collector means greater pressure applied to the positive electrode during cold pressing, and over-pressing of a thicker first region causes the width of the first region to extend more than the thinner third region (that is, the pure current collector region), indicating that more microcracks may be generated inside the positive electrode current collector after cold pressing. More microcracks means more exposed defects, and in the presence of hydrofluoric acid, more corrosion of the positive electrode current collector at defect sites, higher dissolution concentration of impurity elements (for example, Si), and more severe interface issues caused by the accumulation of dissolved out products at the positive electrode interface at the two folds at the tail of the wound cell.

The present application reduces, by adding a certain content of lithium salt additive A to the electrolyte, the risk of corrosion and dissolution of the positive electrode current collector caused by hydrofluoric acid generated from the reaction of LiPF₆ with water. Furthermore, when the content y of the lithium salt additive A is greater than or equal to the elongation rate x of the positive electrode current collector, the effect of the lithium salt additive A in alleviating corrosion and dissolution can counteract the deteriorating effect of elongation cracks in the positive electrode current collector after manufacturing on corrosion and dissolution of the positive electrode current collector, ensuring that no abnormalities appear at the positive electrode interface at the two folds at the tail after cycling of the electrochemical apparatus, thereby significantly improving the safety of the electrochemical apparatus.

In some embodiments, x≤0.8. In some embodiments, x≤0.4. In some embodiments, x is 0.1, 0.2, 0.3, 0.4, 0.5, 0.6, 0.7, 0.8, or a value within a range composed of any two of the above values.

In some embodiments, 0.1≤y≤1.5. In some embodiments, 0.5≤y≤1. In some embodiments, y is 0.1, 0.5, 1, 1.5, 2, 2.5, 3, or a value within a range composed of any two of the above values.

In some embodiments, the positive electrode current collector is an aluminum foil, and the aluminum foil includes at least one element selected from Mg, Ti, Cr, Cu, Fe, Mn, Ni, Si, V, Zn, or Gr.

In some embodiments, the content of element aluminum in the positive electrode current collector is greater than or equal to 60%. In some embodiments, the content of element aluminum in the positive electrode current collector is greater than or equal to 70%. In some embodiments, the content of element aluminum in the positive electrode current collector is greater than or equal to 80%. In some embodiments, the content of element aluminum in the positive electrode current collector is greater than or equal to 90%.

In some embodiments, the aluminum foil includes element Si, and based on the total mass of the positive electrode current collector, the mass percentage content of the element Si is less than or equal to 0.5%. In some embodiments, based on the total mass of the positive electrode current collector, the mass percentage content of the element Si is less than or equal to 0.3%. In some embodiments, based on the total mass of the positive electrode current collector, the mass percentage content of the element Si is less than or equal to 0.1%.

In some embodiments, the electrolyte further includes LiPF₆, and based on the mass of the electrolyte, the content of LiPF₆ is z %, with z being in the range of 5 to 20. In some embodiments, z is in the range of 8 to 15. In some embodiments, z is in the range of 10 to 12. In some embodiments, z is 5, 6, 7, 8, 9, 10, 11, 12, 13, 14, 15, 16, 17, 18, 19, 20, or a value within a range composed of any two of the above values.

In some embodiments, 0.01≤y/z≤0.5. In some embodiments, 0.05≤y/z≤0.3. In some embodiments, 0.1≤y/z≤0.2. In some embodiments, y/z is 0.01, 0.05, 0.1, 0.2, 0.3, 0.4, 0.5, or a value within a range composed of any two of the above values.

In some embodiments, a charge cut-off voltage of the electrochemical apparatus is in a range of 4.41 V to 4.5 V.

In some embodiments, the third region is disposed at a winding tail end, and an area of the third region accounts for 15% to 30% of an area of an outermost positive electrode current collector. In some embodiments, the area of the third region accounts for 20% to 25% of the area of the outermost positive electrode current collector. The term “outermost turn” refers to the portion of the cell winding structure that faces towards the outer packaging at the outermost turn. “Outermost positive electrode current collector” refers to the positive electrode current collector at the outermost turn of the cell winding structure.

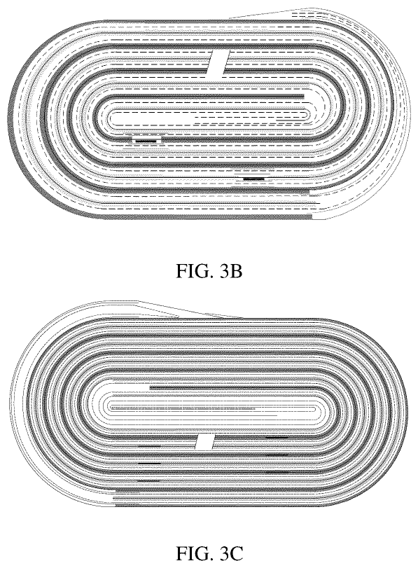

In some embodiments, the electrochemical apparatus includes a wound cell, and the cell has an embedded tab structure (that is, tabs are welded to the blank current collectors at the head and tail) (as shown in FIG. 3A), a non-embedded tab structure (that is, tabs are welded to the middle of the electrode plate) (as shown in FIG. 3B), or a multi-tab structure (that is, multiple tabs are welded to the electrode plate) (as shown in FIG. 3C).

In some embodiments, the positive electrode mixture layer includes a positive electrode active material, a positive electrode binder, and a positive electrode conductive agent.

In some embodiments, the positive electrode active material may include at least one of lithium cobalt oxide, lithium nickel manganese cobalt oxide, lithium nickel manganese aluminum oxide, lithium iron phosphate, lithium vanadium phosphate, lithium cobalt phosphate, lithium manganese phosphate, lithium manganese iron phosphate, lithium iron silicate, lithium vanadium silicate, lithium cobalt silicate, lithium manganese silicate, spinel-type lithium manganese oxide, spinel-type lithium nickel manganese oxide, or lithium titanate.

In some embodiments, the positive electrode binder may include a binder polymer, such as, but not limited to, at least one of polyvinylidene fluoride, polytetrafluoroethylene, polyolefins, sodium carboxymethyl cellulose, lithium carboxymethyl cellulose, modified polyvinylidene fluoride, modified SBR rubber, or polyurethane.

In some embodiments, any conductive material may be used as the positive electrode conductive agent as long as it does not cause chemical changes. Examples of the positive electrode conductive agent include, but are not limited to, carbon-based materials such as natural graphite, artificial graphite, carbon black, acetylene black, Ketjen black, and carbon fiber; metal-based materials such as metal powders or metal fibers including copper, nickel, aluminum, and silver; conductive polymers such as polyphenylene derivatives; or a mixture thereof.

The materials, composition, and manufacturing methods of the negative electrode used in the electrochemical apparatus of the present application may include any technology disclosed in the prior art.

In some embodiments, the negative electrode active material is any substance capable of electrochemically absorbing and releasing metal ions such as lithium ions. In some embodiments, the negative electrode active material includes carbonaceous materials, silicon-carbon materials, alloy materials, or lithium-containing metal composite oxide materials. In some embodiments, the negative electrode active material includes one or more of those described above.

In some embodiments, the negative electrode may be manufactured by any method known in the prior art. In some embodiments, the negative electrode may be prepared by adding a binder and a solvent to the negative electrode active material, and adding a thickener, a conductive material, a filler, and the like as needed, to form a slurry, and applying the slurry onto a current collector, followed by drying and pressing to form the negative electrode.

In some embodiments, when the negative electrode includes an alloy material, the negative electrode active material layer may be formed by methods such as vapor deposition, sputtering, or plating.

In some embodiments, when the negative electrode includes lithium metal, for example, the negative electrode active material layer may be formed with a conductive skeleton having a spherical twisted shape and metal particles dispersed in the conductive skeleton, where the conductive skeleton having a spherical twisted shape may have a porosity of about 5% to about 85%, and a protective layer may further be provided on the lithium metal negative electrode active material layer.

Solvents that can be used in the electrolyte of the embodiments of the present application include, but are not limited to, cyclic carbonates, chain carbonates, cyclic carboxylic acid esters, chain carboxylic acid esters, cyclic ethers, chain ethers, phosphorus-containing organic solvents, sulfur-containing organic solvents, and aromatic fluorine-containing solvents.

In some embodiments, cyclic carbonates include, but are not limited to, ethylene carbonate (EC), propylene carbonate (PC), fluoroethylene carbonate (FEC), and butylene carbonate. In some embodiments, the cyclic carbonate has 3 to 6 carbon atoms.

In some embodiments, chain carbonates include, but are not limited to, dimethyl carbonate (DMC), ethyl methyl carbonate (EMC), diethyl carbonate (DEC), methyl n-propyl carbonate, ethyl n-propyl carbonate, di-n-propyl carbonate, and other chain carbonates, as well as fluorine-substituted chain carbonates such as bis(fluoromethyl)carbonate, bis(difluoromethyl)carbonate, bis(trifluoromethyl) carbonate, bis(2-fluoroethyl)carbonate, bis(2,2-difluoroethyl)carbonate, bis(2,2,2-trifluoroethyl)carbonate, 2-fluoroethyl methyl carbonate, 2,2-difluoroethyl methyl carbonate, and 2,2,2-trifluoroethyl methyl carbonate.

In some embodiments, cyclic carboxylic acid esters include, but are not limited to, γ-butyrolactone and γ-valerolactone. In some embodiments, some hydrogen atoms of the cyclic carboxylic acid ester may be substituted with fluorine.

In some embodiments, chain carboxylic acid esters include, but are not limited to, methyl acetate, ethyl acetate, propyl acetate, isopropyl acetate, butyl acetate, sec-butyl acetate, isobutyl acetate, tert-butyl acetate, methyl propionate, ethyl propionate, propyl propionate, isopropyl propionate, methyl butyrate, ethyl butyrate, propyl butyrate, methyl isobutyrate, ethyl isobutyrate, methyl valerate, ethyl valerate, methyl pivalate, and ethyl pivalate. In some embodiments, some hydrogen atoms of the chain carboxylic acid ester may be substituted with fluorine. In some embodiments, fluorine-substituted chain carboxylic acid esters include, but are not limited to, methyl trifluoroacetate, ethyl trifluoroacetate, propyl trifluoroacetate, butyl trifluoroacetate, and 2,2,2-trifluoroethyl trifluoroacetate.

In some embodiments, cyclic ethers include, but are not limited to, tetrahydrofuran, 2-methyltetrahydrofuran, 1,3-dioxolane, 2-methyl-1,3-dioxolane, 4-methyl-1,3-dioxolane, 1,3-dioxane, 1,4-dioxane, and dimethoxypropane.

In some embodiments, chain ethers include, but are not limited to, dimethoxymethane, 1,1-dimethoxyethane, 1,2-dimethoxyethane, diethoxymethane, 1,1-diethoxyethane, 1,2-diethoxyethane, ethoxymethoxymethane, 1,1-ethoxymethoxyethane, and 1,2-ethoxymethoxyethane.

In some embodiments, phosphorus-containing organic solvents include, but are not limited to, trimethyl phosphate, triethyl phosphate, dimethyl ethyl phosphate, methyl diethyl phosphate, ethylene methyl phosphate, ethylene ethyl phosphate, triphenyl phosphate, trimethyl phosphite, triethyl phosphite, triphenyl phosphite, tris(2,2,2-trifluoroethyl) phosphate, and tris(2,2,3,3,3-pentafluoropropyl) phosphate.

In some embodiments, sulfur-containing organic solvents include, but are not limited to, sulfolane, 2-methylsulfolane, 3-methylsulfolane, dimethyl sulfone, diethyl sulfone, ethyl methyl sulfone, methyl propyl sulfone, dimethyl sulfoxide, methyl methanesulfonate, ethyl methanesulfonate, methyl ethanesulfonate, ethyl ethanesulfonate, dimethyl sulfate, diethyl sulfate, and dibutyl sulfate. In some embodiments, some hydrogen atoms of the sulfur-containing organic solvent may be substituted with fluorine.

In some embodiments, aromatic fluorine-containing solvents include, but are not limited to, fluorobenzene, difluorobenzene, trifluorobenzene, tetrafluorobenzene, pentafluorobenzene, hexafluorobenzene, and trifluoromethylbenzene.

In some embodiments, the solvent used in the electrolyte of the present application includes one or more of those described above. In some embodiments, the solvent used in the electrolyte of the present application includes cyclic carbonates, chain carbonates, cyclic carboxylic acid esters, chain carboxylic acid esters, and combinations thereof. In some embodiments, the solvent used in the electrolyte of the present application includes an organic solvent selected from the group consisting of the following substances: ethylene carbonate, propylene carbonate, diethyl carbonate, ethyl propionate, propyl propionate, n-propyl acetate, ethyl acetate, and combinations thereof. In some embodiments, the solvent used in the electrolyte of the present application includes ethylene carbonate, propylene carbonate, diethyl carbonate, ethyl propionate, propyl propionate, γ-butyrolactone, or combinations thereof.

The material and shape of the separator used in the electrochemical apparatus of the present application are not particularly limited and may include any technology disclosed in the prior art. In some embodiments, the separator includes a polymer or inorganic material formed from a material stable to the electrolyte of the present application. In some embodiments, the separator may include a substrate layer and a surface treatment layer. In some embodiments, the substrate layer is a non-woven fabric, film, or composite film with a porous structure. In some embodiments, the material of the substrate layer includes at least one of polyethylene, polypropylene, polyethylene terephthalate, or polyimide. In some embodiments, the material of the substrate layer includes at least one of a polypropylene porous film, a polyethylene porous film, a polypropylene non-woven fabric, a polyethylene non-woven fabric, or a polypropylene-polyethylene-polypropylene porous composite film.

In some embodiments, a surface treatment layer is provided on at least one surface of the substrate layer, and the surface treatment layer may be a polymer layer or an inorganic layer, or a layer formed by mixing a polymer and an inorganic material.

In some embodiments, the inorganic layer includes inorganic particles and a binder, where the inorganic particles are at least one selected from aluminum oxide, silicon oxide, magnesium oxide, titanium oxide, hafnium oxide, tin oxide, cerium oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is at least one selected from polyvinylidene fluoride, a copolymer of vinylidene fluoride-hexafluoropropylene, polyamide, polyacrylonitrile, polyacrylate, polyacrylic acid, polyacrylate salt, polyvinylpyrrolidone, polyvinyl alkoxide, polymethyl methacrylate, polytetrafluoroethylene, or polyhexafluoropropylene.

In some embodiments, the polymer layer includes a polymer, and the material of the polymer is at least one selected from polyamide, polyacrylonitrile, acrylate polymer, polyacrylic acid, polyacrylate salt, polyvinylpyrrolidone, polyvinyl alkoxide, polyvinylidene fluoride, or poly(vinylidene fluoride-hexafluoropropylene).

In some embodiments, the electrochemical apparatus of the present application includes, but is not limited to, all types of primary batteries, secondary batteries, or capacitors. In some embodiments, the electrochemical apparatus is a lithium secondary battery. In some embodiments, the lithium secondary battery includes, but is not limited to, a lithium metal secondary battery, a lithium-ion secondary battery, a lithium polymer secondary battery, or a lithium-ion polymer secondary battery. In some embodiments, the electrochemical apparatus is a sodium-ion battery.

The present application further provides an electronic apparatus, which includes the electrochemical apparatus described in the present application.

The electronic device or apparatus of the present application is not particularly limited. In some embodiments, the electronic device of the present application includes, but is not limited to, laptops, pen-input computers, mobile computers, e-book readers, portable phones, portable fax machines, portable copiers, portable printers, head-mounted stereo headphones, video recorders, LCD TVs, handheld cleaners, portable CD players, mini discs, transceivers, electronic notebooks, calculators, memory cards, portable recorders, radios, backup power supplies, motors, cars, motorcycles, electric bicycles, bicycles, lighting fixtures, toys, game consoles, clocks, power tools, flashlights, cameras, large household storage batteries, and lithium-ion capacitors.

The preparation process of the electrochemical apparatus and electronic apparatus is well known to those skilled in the art, and the present application imposes no particular limitations. For example, a battery may be prepared by the following method. A positive electrode and a negative electrode are stacked with a separator in between, and winding or folding is performed as needed to form a bare cell. Stainless steel is selected as a packaging shell, the bare cell is placed inside the packaging shell, and an aluminum tab of the bare cell and a pole in a sealing assembly are laser-welded together to achieve electronic conduction between the pole and the bare cell. The steel shell cover and the shell body are connected by laser welding to achieve battery sealing. There is a through-hole on the surface of the steel shell, and the electrolyte is injected into the cell through the through-hole. After sufficient infiltration, the cell is activated under certain current and voltage conditions. Battery preparation is completed at this point.

A lithium-ion battery is used as an example below with reference to specific embodiments to describe the preparation of lithium-ion battery. Those skilled in the art will understand that the preparation methods described in the present application are merely examples, and any other suitable preparation methods are within the scope of the present application.

### Examples

The following describes performance evaluations based on examples and comparative examples of lithium-ion batteries according to the present application.

### I. Preparation of Lithium-Ion Battery

### 1. Preparation of Negative Electrode

Artificial graphite, styrene-butadiene rubber (SBR), and carboxymethyl cellulose (CMC) were mixed in a mass ratio of 95:2:3, and then deionized water was added as a solvent to prepare a slurry with a solid content of 70 wt %. These substances were stirred to uniformity. The slurry was evenly applied on one surface of a copper foil with a thickness of 8 μm, dried at 110° C., and cold-pressed to obtain a negative electrode plate with a negative electrode active material layer applied on one surface, where the negative electrode active material layer had a thickness of 150 μm. The above coating steps were repeated on the other surface of the negative electrode plate to obtain a negative electrode plate with negative electrode active material layers applied on two surfaces. The negative electrode plate was cut into a size of 76 mm×851 mm and welded with tabs for later use.

### 2. Preparation of Positive Electrode

A positive electrode active material lithium cobalt oxide (chemical formula: LiCoO₂), a conductive agent conductive carbon black (Super P), and a binder polyvinylidene fluoride (PVDF) were mixed in a mass ratio of 97:2:1, and N-methylpyrrolidone (NMP) was added as a solvent. These substances were stirred under the action of a vacuum mixer to a positive electrode slurry with a solid content of 75 wt % and a uniform system. The positive electrode slurry was evenly applied on one surface of a positive electrode current collector with a thickness of 10 μm, and dried at 85° C. for 4 h to obtain a positive electrode plate with a positive electrode active material layer (thickness of 110 μm) applied on one surface. Subsequently, the above steps were repeated on the other surface of the positive electrode current collector to obtain a positive electrode plate with positive electrode active material layers applied on two surfaces, followed by cold pressing, cutting, slitting, and drying under vacuum at 85° C. for 4 hours to obtain a positive electrode plate with a size of 74 mm×867 mm for later use. In this positive electrode plate, the positive electrode current collector sequentially included a first region (that is, a region coated on two surfaces), a second region (a region coated on one surface), and a third region (uncoated region) along the length direction.

The elongation rate of the positive electrode current collector can be controlled by adjusting the pressure of the roller during the cold pressing process in the preparation of the positive electrode plate.

### 3. Preparation of Electrolyte

In a dry argon atmosphere glove box, ethylene carbonate (EC), propylene carbonate (PC), ethyl methyl carbonate (EMC), and diethyl carbonate (DEC) were uniformly mixed in a mass ratio of EC:PC:EMC:DEC=1:3:3:3 to form a base solvent. Vinylene carbonate and 1,3-propane sultone were added to the base solvent, followed by the addition of a lithium salt LiPF₆ and a lithium salt additive A (if present), which were dissolved and mixed uniformly to form the electrolyte. Based on the mass of the electrolyte, the mass percentage content of vinylene carbonate was 1%, the mass percentage content of 1,3-propane sultone was 3%, the mass percentage content of LiPF₆ was 12.5%, and the remainder was for EC, PC, EMC, DEC, and lithium salt additive A.

### 5. Preparation of Separator

A polyethylene (PE) porous film with a thickness of 9 μm was selected as a separator substrate. A 2 μm thick heat-resistant layer was applied on one surface of the separator substrate (where, in the heat-resistant layer slurry, based on the total mass of aluminum oxide and the binder PVDF, the mass percentage content of aluminum oxide was 95%, and the mass percentage content of PVDF was 5%). Then, the polyvinylidene fluoride (PVDF) slurry was applied on both sides, and after drying, a final separator was obtained.

### 6. Preparation of Lithium-Ion Battery

The positive electrode, separator, and negative electrode were stacked in sequence, with the separator positioned between the positive electrode and the negative electrode to provide separation, and wound to obtain an electrode assembly. The electrode assembly was placed in an outer packaging aluminum-plastic film, dehydrated at 80° C., and injected with the above electrolyte, followed by sealing. After processes such as standing, formation, capacity grading, degassing, slitting, shaping, and aging, a lithium-ion battery was obtained.

### II. Test Methods

### 1. Test Method for Lithium Salt Content in Electrolyte

The lithium-ion battery was discharged at 0.2C to 3.0 V, and this step was repeated three times to prevent voltage rebound.

In a dry room (water content <2%), the lithium-ion battery was disassembled to take out a bare cell, and the bare cell was quickly placed in a centrifuge tube, and put into a centrifuge. After centrifugation at 3200 revolutions/min for 20-30 min, the centrifuge tube was taken out from the centrifuge, and the centrifuged electrolyte was transferred to a sample vial using a syringe. The sample was injected into a Thermo5 AQUION ion chromatograph for testing (flow rate range: 0.00-5.00 mL/min, maximum pressure: 35 MPa (5000 psi), detection limit≤0.1%, and COV<5%), to obtain the mass percentage contents of different types of lithium salt substances in the total electrolyte.

### 2. Test Method for Trace Doping Element Content in Aluminum Foil

The lithium-ion battery was discharged at 0.2C to 3.0 V, and this step was repeated three times to prevent voltage rebound.

In a dry room (water content <2%), the lithium-ion battery was disassembled to take out a positive electrode, and a blank foil (positive electrode current collector coated with no positive electrode active material) on the positive electrode was cut off. A solution of aqua regia composed of concentrated hydrochloric acid (HCl) and concentrated nitric acid (HNO₃) in a volume ratio of 3:1 was used to dissolve the aluminum foil sample to obtain a completely dissolved ionic solution. The solution was injected into a PE 7000DV ICP plasma emission spectrometer for testing to obtain the mass percentage contents of different types of elemental substances in the total substrate.

3. Method for Determining Condition of Positive Electrode Interface after Cycling of Electrochemical Apparatus

(1) The lithium-ion battery was left standing in a 25° C. environment for 10 min.

(2) Lithium-ion battery charging: It was charged at a constant current of 2.6C to 4.2 V, and then charged at a constant voltage to 2.35C; charged at a constant current of 2.35C to 4.25 V, and then charged at a constant voltage to 2C; charged at a constant current of 2C to 4.3 V, and then charged at a constant voltage to 1.5C; charged at a constant current of 1.5C to 4.38 V, and then charged at a constant voltage to 1.2C; charged at a constant current of 1.2C to 4.45 V, and then charged at a constant voltage to 1C; and charged at a constant current of 1C to 4.48 V, and then charged at a constant voltage to 0.1C.

(3) It was left standing for 10 min.

(4) Discharging of lithium-ion battery: It was discharged at a constant current of 0.2C to 3 V for the initial cycle and every 50 cycles (1, 51, 101, 151 . . . 1001) during cycling, and discharged at a constant current of 1C to 3 V for other cycles.

(5) It was left standing for 10 min.

(6) It was subjected to the above steps (2)-(5) 1001 times.

(7) After cycling is completed, the lithium-ion battery was fully charged again according to step (2), then the cell was disassembled, interface photographs of the fully charged positive electrode were taken, and the condition of the front and back interfaces at the two folds at the tail of the positive electrode were visually observed, to determine whether the interface was normal based on the following criteria:

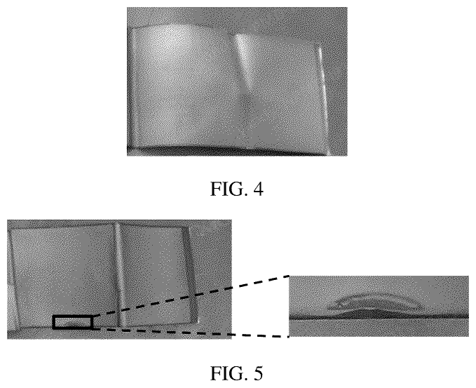

Normal interface: The main region of the front/back interface at the two folds at the tail of the positive electrode was golden yellow, and the region where the positive electrode extended beyond the width of the negative electrode was purple (as shown in FIG. 4), with the lithium precipitation area in the normal interface being less than 2%.

Abnormal interface: Abnormal purple spots, black spots, or lithium precipitation appeared on the front/back interface at the two folds at the tail of the positive electrode (as shown in FIG. 5). The area of the abnormal interface can be calculated by taking pictures under a polarizing microscope and using image processing software to outline the abnormal interface to calculate the area of the abnormal interface. The areas of all abnormal interfaces were summed to obtain the total abnormal interface area. If the total abnormal interface area accounted for no more than 5% and no less than 2% of the total area of the front and back active material layers at the two folds at the tail of the positive electrode, it was considered a mild abnormality. If the total abnormal interface area accounted for more than 5% of the total area of the front and back active material layers at the two folds at the tail of the positive electrode, it was considered a severe abnormality.

Lithium precipitation area=total area of abnormal interfaces/total area of the front and back active material layers at the two folds at the tail of the positive electrode.

### III. Test Results

Table 1 shows the influence of the elongation rate of the positive electrode current collector and the content of the lithium salt additive A in the electrolyte on the interface at the two folds at the tail of the positive electrode after cycling of the lithium-ion battery.

TABLE 1

| | Whether | | Lithium salt additive A | | | | Lithium |
|---|---|---|---|---|---|---|---|
| | y ≥ x is | | | Content | Content z of | | precipitation |
| | satisfied | x | Compound | y (%) | LiPF₆ (%) | y/z | area |
| Example 1 | Yes | 0.05% | LiTFSI | 0.59% | 14.1% | 0.042 | 1.65% |
| Example 2 | Yes | 0.20% | LiTFSI | 0.59% | 14.1% | 0.042 | 1.60% |
| Example 3 | Yes | 0.33% | LiTFSI | 0.59% | 14.1% | 0.042 | 1.51% |
| Example 4 | Yes | 0.40% | LiTFSI | 0.59% | 14.1% | 0.042 | 1.46% |
| Example 5 | Yes | 0.67% | LiTFSI | 0.70% | 14.1% | 0.050 | 1.59% |
| Example 6 | Yes | 0.78% | LiTFSI | 0.92% | 14.1% | 0.065 | 1.78% |
| Example 7 | Yes | 0.40% | LiTFSI | 0.70% | 14.1% | 0.050 | 1.32% |
| Example 8 | Yes | 0.40% | LiTFSI | 1.20% | 14.1% | 0.085 | 1.15% |
| Example 9 | Yes | 0.40% | LiTFSI | 0.59% | 20.0% | 0.030 | 1.68% |
| Example 10 | Yes | 0.40% | LiTFSI | 1.50% | 14.1% | 0.106 | 0.83% |
| Example 11 | Yes | 0.10% | LiTFSI | 0.1% | 10.0 | 0.01 | 0.52% |
| Example 12 | Yes | 0.40% | LiTFSI | 6.25% | 12.5% | 0.5 | 1.37% |
| Example 13 | Yes | 0.40% | LiBF₄ | 0.59% | 14.1% | 0.042 | 1.50% |
| Example 14 | Yes | 0.40% | LiBOB | 0.59% | 14.1% | 0.042 | 1.52% |
| Example 15 | Yes | 0.40% | LiBF₄ + | 0.59% | 14.1% | 0.042 | 1.48% |
| | | | LiTFSI | | | | |
| Comparative | No | 0.67% | LiTFSI | 0.59% | 14.1% | 0.042 | 4.58% |
| Example 1 | | | | | | | |
| Comparative | No | 0.82% | / | / | / | / | 8.10% |
| Example 2 | | | | | | | |
| Comparative | No | 0.40% | LiTFSI | 0.05% | 14.1% | 0.004 | 5.2% |
| Example 3 | | | | | | | |
| Comparative | Yes | 0.40% | / | / | / | / | 6.8% |
| Example 4 | | | | | | | |

“/” indicates not added or not present.

The content of each element in the aluminum foil of the positive electrode current collector used in each example and comparative example in Table 1 is shown in the following table:

| ICP (wt %) | Al | Cr | Cu | Fe | Mg | Mn | Ni | Si | Ti | V | Zn | Zr |
|---|---|---|---|---|---|---|---|---|---|---|---|---|
| Aluminum | 98.651% | ND | 0.375% | 0.386% | ND | ND | 0.016% | 0.532% | 0.022% | 0.012% | 0.006% | ND |
| foil | | | | | | | | | | | | |

The results show that when the electrolyte does not contain the lithium salt additive A or the content (y %) of the lithium salt additive A in the electrolyte is less than the elongation rate (x) of the positive electrode current collector, an abnormal interface appears at the two folds at the tail of the positive electrode after cycling of the lithium-ion battery, posing serious safety hazards to the lithium-ion battery. When the electrolyte contains 0.1%-3% of lithium salt additive A and its content is greater than or equal to the elongation rate of the positive electrode current collector, the interface at the two folds at the tail of the positive electrode after cycling of the lithium-ion battery is normal, significantly improving the safety of the lithium-ion battery.

When the elongation rate (x) of the positive electrode current collector is less than or equal to 0.8, especially less than or equal to 0.4, the interface at the two folds at the tail of the positive electrode after cycling of the lithium-ion battery can be further improved, thereby further enhancing the safety of the lithium-ion battery. The content of the lithium salt additive A in the electrolyte is in the range of 0.1%-1.5% helps to further enhance the safety of the lithium-ion battery.

When the electrolyte further contains 5%-20% of LiPF₆, the safety of the lithium-ion battery can be further improved.

When the content ratio (y/z) of the lithium salt additive A to LiPF₆ in the electrolyte is in the range of 0.01-0.5, the interface at the two folds at the tail of the positive electrode after cycling of the lithium-ion battery can be further improved, enhancing the safety of the lithium-ion battery.

Table 2 shows the composition of the positive electrode current collector in Example 16 and the condition of the interface at the two folds at the tail of the positive electrode after cycling of the lithium-ion battery. Except for the composition of the aluminum foil, the other conditions of Example 16 are consistent with those of Example 4.

TABLE 2

| | | | | | | | | | | | | | Lithium |
|---|---|---|---|---|---|---|---|---|---|---|---|---|---|
| | Elements and their contents in aluminum foil (wt %) | | | | | | | | | | | | precipitation |
| Example | Al | Cr | Cu | Fe | Mg | Mn | Ni | Si | Ti | V | Zn | Zr | area |
| Example 4 | 98.651% | ND | 0.375% | 0.386% | ND | ND | 0.016% | 0.532% | 0.022% | 0.012% | 0.006% | ND | 1.46% |
| Example 16 | 99.071% | ND | 0.405% | 0.363% | ND | ND | 0.021% | 0.096% | 0.017% | 0.018% | 0.009% | ND | 0.68% |

The results show that when the positive electrode current collector is an aluminum foil containing a doping element (at least one of element Mg, Ti, Cr, Cu, Fe, Mn, Ni, Si, V, Zn, or Gr) and when the mass percentage content of element Si in the aluminum foil is less than or equal to 0.5%, the improvement effect is particularly significant.

Furthermore, when the first region is disposed at the tail end of the positive electrode current collector and the area of the first region accounts for 15% to 30% of the area of the outermost positive electrode current collector, not only can the energy density of the electrochemical apparatus be improved, but excessive contact between the blank positive electrode current collector and the electrolyte can also be avoided, thereby reducing the risk of corrosion of the positive electrode current collector. This can further improve the interface at the two folds at the tail of the positive electrode after cycling of the lithium-ion battery, thereby further enhancing the safety of the lithium-ion battery.

Throughout the specification, references to “embodiment”, “some embodiments”, “one embodiment”, “another example”, “example”, “specific example”, or “some examples” mean that at least one embodiment or example in the present application includes the specific feature, structure, material, or characteristic described in that embodiment or example. Therefore, descriptions appearing in various places throughout the specification, such as “in some embodiments”, “in an embodiment”, “in one embodiment”, “in another example”, “in an example”, “in a specific example”, or “example”, do not necessarily refer to the same embodiment or example in the present application. Furthermore, the specific features, structures, materials, or characteristics herein may be combined in any suitable manner in one or more embodiments or examples.

Although illustrative embodiments have been demonstrated and described, those skilled in the art should understand that the above embodiments should not be construed as limiting the present application, and changes, substitutions, and modifications may be made to the embodiments without departing from the spirit, principles, and scope of the present application.

What is claimed is:

1. An electrochemical apparatus, comprising a positive electrode and an electrolyte; wherein,
the positive electrode comprises a positive electrode current collector and a positive electrode mixture layer disposed on a surface of the positive electrode current collector; the positive electrode current collector comprises a first region, a second region, and a third region; two surfaces of the first region are each provided with the positive electrode mixture layer, one surface of the second region is provided with the positive electrode mixture layer, and neither surface of the third region is provided with the positive electrode mixture layer; and an average width of the first region is a centimeters, an average width of the third region is b centimeters, and an elongation rate of the positive electrode current collector is x, wherein x=a/b−1; and
the electrolyte comprises a lithium salt additive A; the lithium salt additive A is at least one selected from lithium tetrafluoroborate, lithium bis(oxalato)borate, lithium difluoro(oxalato)borate, lithium difluorophosphate, lithium difluoro bis(oxalato)phosphate, lithium bis(fluorosulfonyl)imide, or lithium bis(trifluoromethanesulfonyl)imide; and based on a mass of the electrolyte, a mass content of the lithium salt additive A is y %, and y is in the range of 0.1 to 3;
wherein y≥x.

2. The electrochemical apparatus according to claim 1, wherein x≤0.8.

3. The electrochemical apparatus according to claim 1, wherein x≤0.4.

4. The electrochemical apparatus according to claim 1, wherein 0.1≤y≤1.5.

5. The electrochemical apparatus according to claim 1, wherein the positive electrode current collector is an aluminum foil; and the aluminum foil comprises at least one element selected from Mg, Ti, Cr, Cu, Fe, Mn, Ni, Si, V, Zn, or Gr.

6. The electrochemical apparatus according to claim 5, wherein a mass content of element aluminum in the positive electrode current collector is greater than or equal to 60%.

7. The electrochemical apparatus according to claim 5, wherein the aluminum foil comprises element Si; and based on a total mass of the positive electrode current collector, a mass percentage content of the element Si is less than or equal to 0.5%.

8. The electrochemical apparatus according to claim 1, wherein the electrolyte further comprises LiPF₆; and based on a mass of the electrolyte, a mass content of LiPF₆ is z %, z is in the range of 5 to 20.

9. The electrochemical apparatus according to claim 1, wherein 0.01≤y/z≤0.5.

10. The electrochemical apparatus according to claim 1, wherein a charge cut-off voltage of the electrochemical apparatus is in a range of 4.41 V to 4.5 V.

11. The electrochemical apparatus according to claim 1, wherein the electrochemical apparatus comprises a wound cell; the third region is disposed at a tail end of the positive electrode current collector, the tail end is an outermost positive electrode current collector, which is an outermost layer of the wound cell; and a ratio of an area of the third region to an area of an outermost positive electrode current collector is 15% to 30%.

12. An electronic apparatus, comprising an electrochemical apparatus; the electrochemical apparatus comprises a positive electrode and an electrolyte; wherein,
the positive electrode comprises a positive electrode current collector and a positive electrode mixture layer disposed on a surface of the positive electrode current collector; the positive electrode current collector comprises a first region, a second region, and a third region; two surfaces of the first region are each provided with the positive electrode mixture layer, one surface of the second region is provided with the positive electrode mixture layer, and neither surface of the third region is provided with the positive electrode mixture layer; and an average width of the first region is a centimeters, an average width of the third region is b centimeters, and an elongation rate of the positive electrode current collector is x, wherein x=a/b−1; and
the electrolyte comprises a lithium salt additive A; the lithium salt additive A is at least one selected from lithium tetrafluoroborate, lithium bis(oxalato)borate, lithium difluoro(oxalato)borate, lithium difluorophosphate, lithium difluoro bis(oxalato)phosphate, lithium bis(fluorosulfonyl)imide, or lithium bis(trifluoromethanesulfonyl)imide; and based on a mass of the electrolyte, a mass content of the lithium salt additive A is y %, and y is in the range of 0.1 to 3;
wherein y≥x.

13. The electronic apparatus according to claim 12, wherein x≤0.8.

14. The electronic apparatus according to claim 12, wherein x≤0.4.

15. The electronic apparatus according to claim 12, wherein 0.1≤y≤1.5.

16. The electronic apparatus according to claim 12, wherein the positive electrode current collector is an aluminum foil, and the aluminum foil comprises at least one element selected from Mg, Ti, Cr, Cu, Fe, Mn, Ni, Si, V, Zn, or Gr.

17. The electronic apparatus according to claim 16, wherein a mass content of element aluminum in the positive electrode current collector is greater than or equal to 60%.

18. The electronic apparatus according to claim 16, wherein the aluminum foil comprises element Si; and based on a total mass of the positive electrode current collector, a mass percentage content of the element Si is less than or equal to 0.5%.

19. The electronic apparatus according to claim 12, wherein the electrolyte further comprises LiPF₆; and based on a mass of the electrolyte, a mass content of LiPF₆ is z %, z is in the range of 5 to 20, 0.01≤y/z≤0.5.

20. The electrochemical apparatus according to claim 12, wherein a charge cut-off voltage of the electrochemical apparatus is in a range of 4.41 V to 4.5 V.
